(19) United States
(12) Patent Application Publication
(10) Pub. No.: US 2010/0007635 A1
(43) Pub. Date: Jan. 14, 2010

(54) GATE DRIVER AND DISPLAY APPARATUS HAVING THE SAME

(75) Inventors: Yeong-Keun KWON, Suwon-si (KR); Jeong-Il KIM, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 12/327,282

(22) Filed: Dec. 3, 2008

(30) Foreign Application Priority Data
Jul. 8, 2008 (KR) 10-2008-0066228

(51) Int. Cl. G09G 5/00

(52) U.S. Cl. 345/204

(57) ABSTRACT

A gate driver includes; a plurality of driving stages including; an input terminal which receives a previous carry signal from a previous driving stage, a control terminal which receives a next gate signal from a subsequent stage, an output terminal which outputs a gate signal and is connected to the control terminal of the subsequent stage, a carry terminal which outputs a present carry signal and is connected to the input terminal of the subsequent stage, and a reset terminal which receives a reset signal, and a dummy stage including; an input terminal which receives a carry signal from a last driving stage, a control terminal which receives a control signal, a first output terminal which applies the reset signal to the reset terminal of each of the driving stages, and a second output terminal which applies a dummy gate signal to the control terminal of the last driving stage.

This application claims priority to Korean Patent Application No. 2008-66228, filed on Jul. 8, 2008, and all the benefits accruing therefrom under 35 U.S.C. §119, the contents of which in its entirety are herein incorporated by reference.

### BACKGROUND OF THE INVENTION

1. Field of the Invention

The present invention relates to a gate driver and a display apparatus having the same. More particularly, the present invention relates to a gate driver capable of preventing a malfunction thereof and a display apparatus having the gate driver.

2. Description of the Related Art

In general, a liquid crystal display (“LCD”) includes an LCD panel that displays an image. The LCD panel includes a lower substrate, an upper substrate facing the lower substrate, and a liquid crystal layer interposed between the lower and upper substrates.

The LCD panel includes a plurality of gate lines, a plurality of data lines, and a plurality of pixels each of which is connected to a corresponding gate line of the gate lines and a corresponding data line of the data lines. The LCD panel includes a gate driving circuit that sequentially applies a gate signal to the gate lines. The gate driving circuit is directly formed through a thin film process.

The gate driving circuit includes a shift register in which a plurality of driving stages are connected to each other one after another and sequentially outputs the gate signal. Each driving stage outputs the gate signal to a corresponding gate line of the gate lines in response to a carry signal applied from a previous stage and applies the carry signal to a next stage.

In addition, each driving stage is turned off by a gate signal applied from the next driving stage, however a method of turning off a last stage of the driving stages is required since there is no subsequent stage to turn off the last stage of the driving stages.

### BRIEF SUMMARY OF THE INVENTION

Exemplary embodiments of the present invention include a gate driver capable of improving driving characteristics of a last driving stage thereof and normally resetting each driving stage thereof.

Another exemplary embodiment of the present invention also provides a display apparatus having the exemplary embodiment of a gate driver.

In one exemplary embodiment of the present invention, a gate driver includes: a plurality of driving stages, each of the driving stages including; an input terminal which receives a previous carry signal from a previous driving stage, a control terminal which receives a next gate signal from a subsequent driving stage, an output terminal which outputs a present gate signal and is connected to the control terminal of the subsequent driving stage, a carry terminal which outputs a present carry signal and is connected to the input terminal of the subsequent driving stage, and a reset terminal which receives a reset signal, and a dummy stage including; an input terminal which receives a last carry signal from a last driving stage of the plurality of driving stages, a control terminal which receives a control signal, a first output terminal which applies the reset signal to the reset terminal of each of the plurality of driving stages, and a second output terminal which applies a dummy gate signal to the control terminal of the last driving stage of the driving stages.

In another exemplary embodiment of the present invention, a display apparatus includes a display panel including; a plurality of gate lines, a plurality of data lines disposed substantially perpendicular to the plurality of gate lines, and a plurality of pixels, each of which is connected to at least one of the plurality of gate liens and at least one of the plurality of data lines, a data driver which applies a data signal to the plurality of data lines, and a gate driver which sequentially applies a gate signal to the plurality of gate lines, wherein the gate driver includes; a plurality of driving stages, each of which includes; an input terminal which receives a previous carry signal from a previous driving stage, a control terminal which receives a next gate signal from a subsequent driving stage, an output terminal which outputs a present gate signal and is connected to the control terminal of the subsequent driving stage, a carry terminal which outputs a present carry signal and is connected to the input terminal of the subsequent driving stage, and a reset terminal which receives a reset signal, and a dummy stage which includes: an input terminal which receives a last carry signal from a last driving stage of the plurality of driving stages, a control terminal which receives a control signal, a first output terminal which applies the reset signal to the reset terminal of each of the plurality of driving stages, and a second output terminal which applies a dummy gate signal to the control terminal of the last driving stage of the plurality of driving stages.

According to the above, the dummy stage receives the last carry signal from the last driving stage to output the reset signal and the dummy gate signal. The reset signal output from the dummy stage is input to the reset terminal of each of the driving stages, and the dummy gate signal is applied to the control terminal of the last driving stage.

Thus, the dummy gate signal applied to the last driving stage may be prevented from being distorted and the last driving stage may be normally turned off by the dummy gate stage, thereby preventing line defects from occurring on a display panel.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram illustrating an exemplary embodiment of a gate driver according to the present invention;

FIG. 2 is an equivalent circuit diagram illustrating an exemplary embodiment of a last driving stage of FIG. 1;

FIG. 3 is an equivalent circuit diagram illustrating an exemplary embodiment of a dummy stage of FIG. 1;

FIG. 4 is a waveform diagram illustrating gate signals output from a conventional gate driver;

FIG. 5 is a waveform diagram illustrating exemplary embodiments of gate signals output from an exemplary embodiment of a gate driver according to the present invention;

FIG. 6 is a top plan layout view illustrating an exemplary embodiment of a display apparatus according to the present invention; and

FIG. 7 is a waveform diagram illustrating signals applied to gate lines of the exemplary embodiment of a display apparatus of FIG. 6.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on to the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

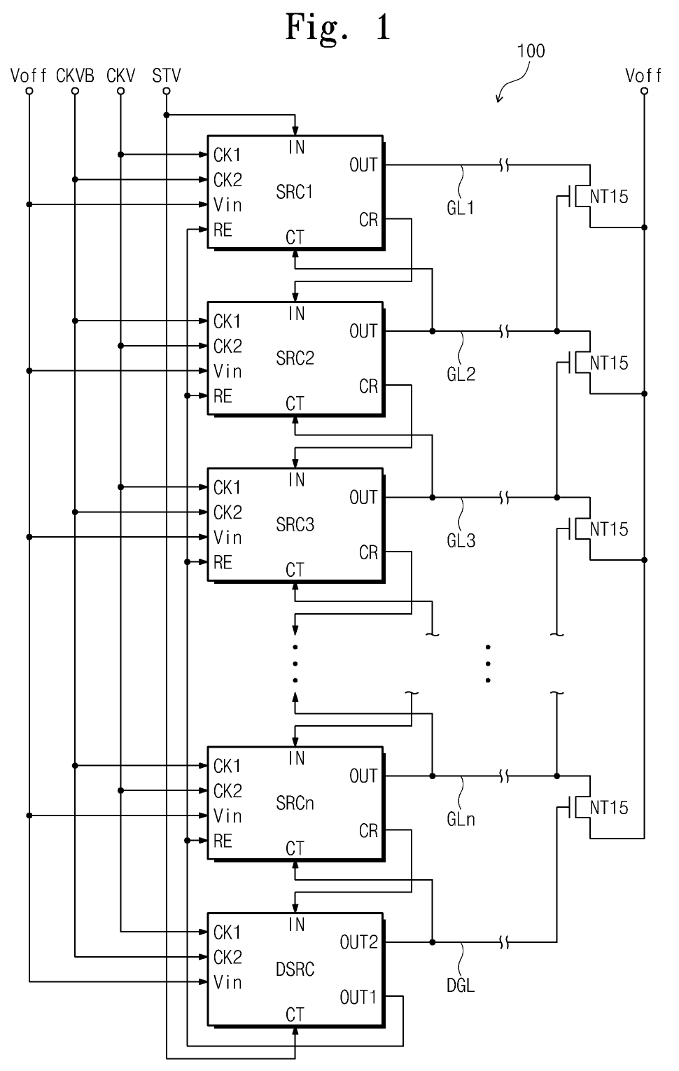

FIG. 1 is a block diagram illustrating an exemplary embodiment of a gate driver according to the present invention.

Referring to FIG. 1, a gate driver 100 includes a shift register. The shift register includes a plurality of driving stages SRC1˜SRCn connected to each other one after another and a dummy stage DSRC. The shift register is located at a position adjacent to first ends of the gate lines GL1˜GLn.

Each of the driving stages SRC1˜SRCn includes an input terminal IN, a first clock terminal CK1, a second clock terminal CK2, a control terminal CT, a voltage input terminal Vin, a reset terminal RE, an output terminal OUT, and a carry terminal CR. The dummy stage DSRC includes the input terminal IN, the first and second clock terminals CK1 and CK2, the control terminal CT, the voltage input terminal Vin, a first output terminal OUT1, and a second output terminal OUT2.

The input terminal IN of each of the driving stages SRC2˜SRCn is electrically connected to the carry terminal CR of a previous driving stage to receive a previous carry signal. A vertical start signal STV that starts an operation of the gate driver 100 is applied to the input terminal IN of a first driving stage SRC1 of the driving stages SRC1˜SRCn in lieu of the previous carry signal. The control terminal CT of each driving stage is electrically connected to the output terminal OUT of a next stage to receive a next gate signal. However, the control terminal CT of a last driving stage SRCn of the driving stages SRC1˜SRCn is electrically connected to the second output terminal OUT2 of the dummy stage DSRC. In the present exemplary embodiment, the vertical start signal STV is applied to the control terminal CT of the dummy stage DSRC in lieu of the gate signal from a subsequent stage.

The first clock terminal CK1 of odd-numbered driving stages SRC1, SRC3, SRCn-1 of the driving stages SRC1˜SRCn receives a first clock CKV and the second clock terminal CK2 of odd-numbered driving stages SRC1, SRC3, . . . , SRCn-1 of the driving stages SRC1˜SRCn receives a second clock CKVB having a substantially opposite phase to the first clock CKV The first clock terminal CK1 of even-numbered driving stages SRC2, . . . , SRCn of the driving stages SRC1˜SRCn receives the second clock CKVB, and the second clock terminal CK2 of even-numbered driving stages SRC2, . . . , SRCn of the driving stages SRC1˜SRCn receives the first clock CKV. In the exemplary embodiment wherein n is an even number, the first and second clock terminals CK1 and CK2 of the dummy stage DSRC receive the first and second clocks CKV and CKVB, respectively. In the exemplary embodiment wherein n is an odd-number, the first and second clock terminals CK1 and CK2 of the dummy stage DSRC receive the second and first clock signals CK2 and CK1, respectively.

The voltage input terminal Vin of the driving stages SRC1˜SRCn and the dummy stage DSRC receive a gate-off voltage Voff. Exemplary embodiments include configurations wherein the gate-off voltage may be a ground voltage or a negative voltage.

The output terminal OUT of each of the driving stages SRC1˜SRcn is electrically connected to a corresponding gate line of the gate lines GL1˜GLn. Thus, the driving stages SRC1˜SRCn sequentially output the gate signal through the output terminal to apply the gate signal to the gate lines GL1˜GLn.

The carry terminal CR of each of the driving stages SRC1˜SRCn is electrically connected to the input terminal IN of the next stage and applies a carry signal to the input terminal IN of the next stage. The carry terminal CR of the last driving stage SRCn is electrically connected to the input terminal IN of the dummy stage DSRC.

The first output terminal OUT1 of the dummy stage DSRC is electrically connected to the reset terminal RE of the driving stages SRC1˜SRCn, and the second output terminal OUT2 of the dummy stage DSRC is electrically connected to the control terminal CT of the last driving stage SRCn. Accordingly, the dummy stage DSRC applies a reset signal to the reset terminal RE of the driving stages SRC1˜SRCn to reset the driving stages DRC1˜SRCn. In addition, the dummy stage DSRC applies a dummy output signal to the control terminal CT of the last driving stage SRCn in order to lower a voltage level of the gate signal output from the last driving stage SRCn.

Each of the driving stages SRC1˜SRCn includes a discharge transistor NT15 connected to second ends of the gate lines GL1˜GLn. The discharge transistor NT15 includes a control electrode connected to a next gate line, an input electrode receiving the gate-off voltage Voff, and an output electrode connected to a present gate line. Thus, the discharge transistor NT15 discharges the present gate line to the gate-off voltage Voff in response to the next gate signal output from the next driving stage.

In the present exemplary embodiment, the control electrode of the last discharge transistor NT15 applied to discharge the last gate line GLn is electrically connected to the second output terminal OUT2 of the dummy stage DSRC through the dummy gate line DGL. Accordingly, the last discharge transistor NT15 discharges the last gate line GLn to the gate-off voltage Voff in response to the dummy output signal output from the second output terminal OUT2 of the dummy stage DSRC.

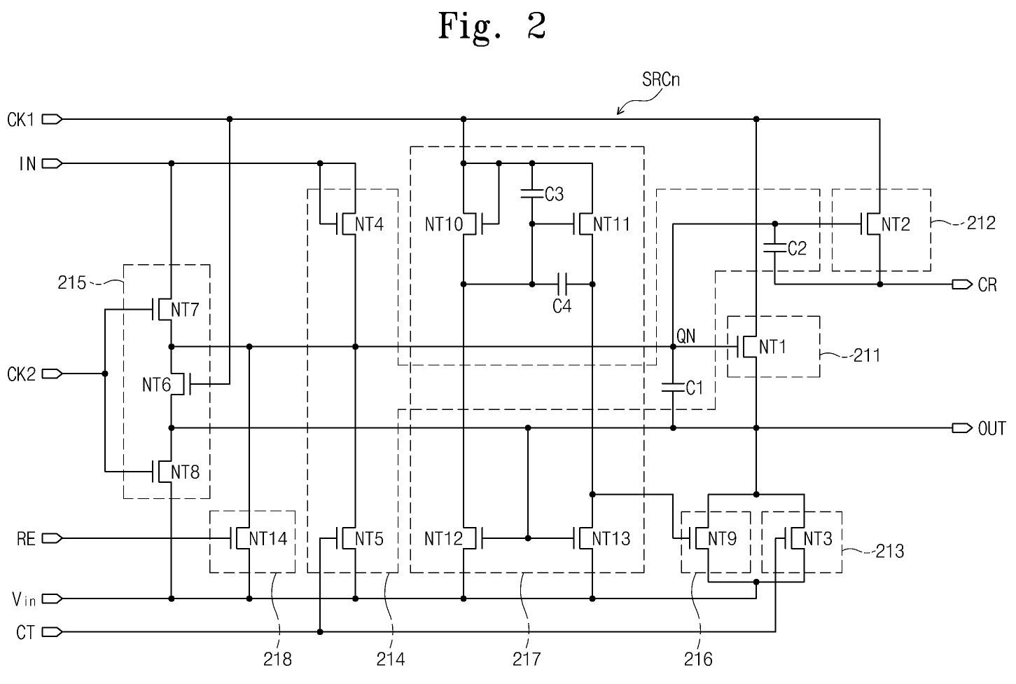

FIG. 2 is an equivalent circuit diagram illustrating an exemplary embodiment of a last driving stage of FIG. 1. In FIG. 2, the last driving stage SRCn will be described in detail as the representative example since the driving stages SRC1˜SRCn of the gate driver 100 have substantially the same circuit configuration and function.

Referring to FIG. 2, the last driving stage SRCn includes a pull-up part 211, a carry part 212, a pull-down part 213, a pull-up driving part 214, a ripple preventing part 215, a holding part 216, an inverter part 217, and a reset part 218.

The pull-up part 211 includes a pull-up transistor NT1 having a control electrode connected to an output (hereinafter, referred to as Q-node QN) of the pull-up driving part 214, an input electrode connected to the first clock terminal CK1, and an output electrode connected to the output terminal OUT. The pull-up transistor NT1 pulls up the present gate signal output through the output terminal OUT to a high level of the clock (hereinafter, referred to as second clock CKVB, see FIG. 1) applied through the first clock terminal CK1 in response to the voltage output from the pull-up driving part 213. The pull-up transistor NT1 is turned on during a high period (hereinafter, referred to as a first period) of the second clock CKVB within one frame to maintain the present gate signal in a high stage during the first period.

The carry part 212 includes a carry transistor NT2 having a control electrode connected to the Q-node QN, an input electrode connected to the first clock terminal CK1, and an output electrode connected to the carry terminal CR. The carry transistor NT2 pulls up a present carry signal output through the carry terminal CR to the high level of the second clock CKVB in response to the voltage output from the pull-up driving part 211. The carry transistor NT2 is turned on during the first period within the one frame to maintain the present carry signal in the high state.

The pull-down part 213 includes a pull-down transistor NT3 having a control electrode connected to the control terminal CT, an input electrode connected to the voltage input terminal Vin, and an output electrode connected to the output terminal OUT. The pull-down transistor NT3 pulls down the pulled-up present gate signal to the gate-off voltage Voff (see FIG. 1) applied through the voltage input terminal Vin in response to the next gate signal from a subsequent stage. That is, the pull-down transistor NT3 is turned on by the next gate signal after the first period to pull down the present gate signal to a low state.

The pull-up driving part 214 includes a buffer transistor NT4, a first capacitor C1, a second capacitor C2, and a discharge transistor NT5. The buffer transistor NT4 includes an input electrode and a control electrode that are commonly connected to the input terminal IN, and an output electrode connected to the Q-node QN. The first capacitor Cl is connected between the Q-node QN and the output terminal OUT, and the second capacitor C2 is connected between the control electrode of the carry transistor NT2 of the carry transistor NT2 and the carry terminal CR, to which the output terminal of the carry transistor NT2 is connected. The discharge transistor NT5 includes an input electrode connected to the output electrode of the buffer transistor NT4, a control electrode connected to the control terminal CT, and an output electrode connected to the voltage input terminal Vin.

When the buffer transistor NT4 is turned on in response to the previous carry signal, an electric potential of the Q-node QN increases, so that the pull-up transistor NT1 and the carry transistor NT2 are turned on. When the electric potential of the output terminal OUT and the carry terminal CR increases by the turned-on pull-up transistor NT1 and the turned-on carry transistor NT2, the electric potential of the Q-node QN is boosted up by the potential stored in the first and second capacitors Cl and C2. Accordingly, the pull-up transistor NT1 and the carry transistor NT2 are maintained in the turn-on state, so that the present gate signal and the present carry signal may be generated at the high state during the first period of the second clock CKVB.

When the discharge transistor NT5 is turned on in response to the next gate signal, electric charges charged in the first capacitor Cl are discharged to the gate-off voltage Voff through the discharge transistor NT5. Thus, the electric potential of the Q-node QN is lowered to the gate-off voltage Voff, thereby turning off the pull-up transistor NT1 and the carry transistor NT2. As a result, the present gate signal in the high state and the carry signal are not output through the output terminal OUT and the carry terminal CR.

The ripple preventing part 215 includes first, second and third ripple preventing transistors NT6, NT7 and NT8, respectively, and prevents the present gate signal and the present carry signal from being rippled by the first clock CKV or the second clock CKVB during a second period of the one frame. In the present exemplary embodiment, the second period corresponds to a remaining period of the one frame except the first period, so that the first and second periods combined equal a period of one frame. In one exemplary embodiment, the first period will be significantly shorter than the second period as the time period for applying a gate-on signal to the respective gate line will be shorter than the time period for applying a gate-off signal to the respective gate line.

The first ripple preventing transistor NT6 includes a control electrode connected to the first clock terminal CK1, an input electrode connected to the output terminal OUT, and an output electrode connected to the Q-node QN. The second ripple preventing transistor NT7 includes a control electrode connected to the second clock terminal CK2, an input electrode connected to the input terminal IN, and an output electrode connected to the Q-node QN. The third ripple preventing transistor NT8 includes a control electrode connected to the second clock terminal CK2, an input electrode connected to the output terminal OUT, and an output electrode connected to the voltage input terminal Vin.

The first ripple preventing transistor NT6 applies the present gate signal in the low state, which is output from the output terminal OUT, to the Q-node QN in response to the second clock CKVB during the second period. Accordingly, the electric potential of the Q-node QN is maintained in the low state during the high period of the second clock CKVB within the second period. Thus, the first ripple preventing transistor NT6 may prevent the pull-up transistor NT1 and the carry transistor NT2 from being turned on during the high period of the second clock CKVB within the second period.

During the second period, the second ripple preventing transistor NT7 applies the previous carry signal in the low state provided through the input terminal IN to the Q-node QN in response to the clock (hereinafter, referred to as first clock CKV, see FIG. 1) applied through the second clock terminal CK2. Thus, the electric potential of the Q-node QN is maintained in the low state during the high period of the first clock CKV with the second period. As a result, the second ripple preventing transistor NT7 may prevent the pull-up transistor NT1 and the carry transistor NT2 from being turned on during the high period of the first clock CKV within the second period.

The third ripple preventing transistor NT8 discharges the present gate signal to the gate-off voltage Voff in response to the first clock CKV Accordingly, the third ripple preventing transistor NT8 may maintain the present gate signal in the gate-off voltage Voff during the high period of the first clock CKV within the second period.

The holding part 216 includes a holding transistor NT9 having a control electrode connected to an output of the inverter part 217, an input electrode connected to the voltage input terminal Vin, and an output electrode connected to the output terminal OUT. The inverter part 217 includes first, second, third and fourth inverter transistors NT10, NT11, NT12 and NT13, respectively, a third capacitor C3, and a fourth capacitor C4 to turn on or off the holding transistor NT9.

The first inverter transistor NT10 includes an input electrode and a control electrode that are commonly connected to the first clock terminal CK1, and an output electrode connected to an output electrode of the second inverter transistor NT11 through the fourth capacitor C4. The second inverter transistor NT11 includes an input electrode connected to the first clock terminal CK1, a control electrode connected to the input electrode through the third capacitor C3, and an output electrode connected to the control electrode of the holding transistor NT9. The third inverter transistor NT12 includes an input electrode connected to the output electrode of the first inverter transistor NT10, a control electrode connected to the output terminal OUT, and an output electrode connected to the voltage input terminal Vin. The fourth inverter transistor NT13 includes an input electrode connected to the control electrode of the holding transistor NT9, a control electrode connected to the output terminal OUT, and an output electrode connected to the voltage input terminal Vin.

When the third and fourth inverter transistors NT12 and NT13 are turned on in response to the present gate signal of the high state output through the output terminal OUT, the second clock CKVB output from the first and second inverter transistors NT10 and NT11 is discharged to the gate-off voltage Voff supplied to the Vin terminal by the turned-on third and fourth inverter transistors NT12 and NT13. Thus, the holding transistor NT9 is maintained in the turned-off state during the first period in which the present gate signal is maintained in the high state.

Then, when the present gate signal transitions to the low state in the second period, the third and fourth inverter transistors NT12 and NT13 are turned off. Accordingly, the second clock CKVB output from the first and second inverter transistors NT10 and NT11 is applied to the holding transistor NT9, and the holding transistor NT9 is turned on. Consequently, the present gate signal may be held at the potential of the gate-off voltage Voff during the high period of the second clock CKVB within the second period.

The reset part 218 includes a reset transistor NT14 having a control electrode connected to the reset terminal RE, an output electrode connected to the control electrode of the pull-up transistor NT1, and an input electrode connected to the voltage input terminal Vin.

The reset transistor NT14 discharges the electric potential of the Q-node QN to the gate-off voltage Voff in response to the reset signal output from the first output terminal OUT1 of the dummy stage DSRC (see FIG. 1) and input into the present driving stage SRCn through the reset terminal RE thereof. Therefore, the pull-up transistor NT1 and the carry transistor NT2 are turned off in response to the reset signal of the dummy stage DSRC. As shown in FIG. 1, the reset signal of the dummy stage DSRC is applied to the driving stages SRC1˜SRCn to turn off the pull-up transistor NT1 and the carry transistor NT2 in each of the driving stages SRC1˜SRCn, thereby resetting all the driving stages SRC1˜SRCn.

While the above exemplary embodiment of a driving stage has been discussed as having a second clock signal CKVB applied to the first clock terminal CK1 thereof and the first clock signal CKV applied to the second clock terminal CK2 thereof, individual driving stages may have different configurations wherein the clock signals are reversed from the exemplary arrangement discussed above, as is apparent from the illustration of an exemplary embodiment of a gate driver 100 shown in FIG. 1.

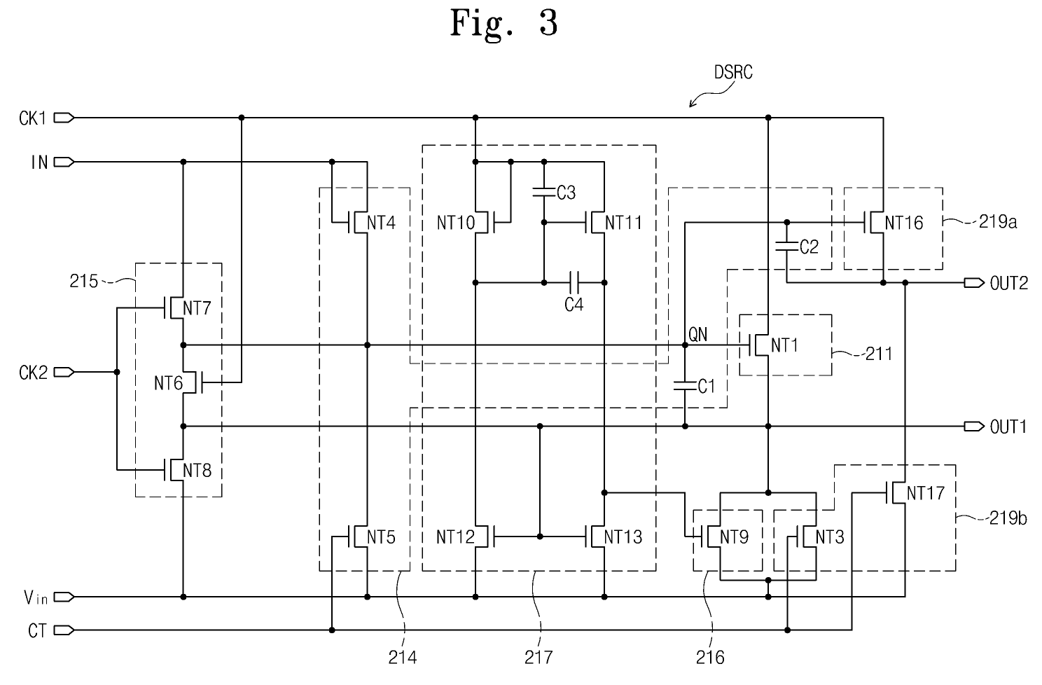

FIG. 3 is an equivalent circuit diagram illustrating an exemplary embodiment of a dummy stage of FIG. 1. In FIG. 3, the same reference numerals denote the same elements in FIG. 2, and thus detailed descriptions of the same elements will be omitted.

Referring to FIG. 3, the dummy stage DSRC includes a first pull-up part 211, a second pull-up part 219a, a pull-down part 219b, a pull-up driving part 214, a ripple preventing part 215, a holding part 216, and an inverter part 217.

The first pull-up part 211 includes a first pull-up transistor NT1 having a control electrode connected to the output (hereinafter, Q-node “QN”) of the pull-up driving part 214, an input electrode connected to the first clock terminal CK1, and an output electrode connected to the first output terminal OUT1. Responsive to the voltage output from the pull-up driving part 214, the first pull-up transistor NT1 pulls up the reset voltage output through the first output terminal OUT1 to the high level of the clock (hereinafter, first clock CKV, see FIG. 1) applied through the first clock terminal CK1.

The second pull-up part 219a includes a second pull-up transistor NT16 having a control electrode connected to the Q-node QN, an input electrode connected to the first clock terminal CK1, and an output electrode connected to the second output terminal OUT2. The second pull-up transistor NT16 pulls up the dummy gate signal output through the second output terminal OUT2 to the high level of the first clock CKV in response to the voltage output from the pull-up driving part 214.

In the present exemplary embodiment, the second pull-up transistor NT16 has a size smaller than that of the first pull-up transistor NT1. As an example of the present invention, when the first pull-up transistor NT1 has the same channel length as the second pull-up transistor NT16, the first pull-up transistor NT1 has a channel width of about 6,030 micrometers and the second pull-up transistor NT16 has a channel width of about 700 micrometers.

The pull-down part 219b includes a first pull-down transistor NT3 and a second pull-down transistor NT17. The first pull-down transistor NT3 includes a control electrode connected to the control terminal CT, an input electrode connected to the voltage input terminal Vin, and an output electrode connected to the first output terminal OUT1. The second pull-down transistor NT17 includes a control electrode connected to the control terminal CT, an input electrode connected to the voltage input terminal Vin, and an output electrode connected to the second output terminal OUT2.

Responsive to the vertical start signal, the first and second pull-down transistors NT3 and NT17 pulls down the reset voltage and the dummy gate signal to the gate-off voltage Voff applied through the voltage input terminal Vin.

In the present exemplary embodiment, the second pull-down transistor NT17 has a size smaller than that of the first pull-down transistor NT3. As an example of the present invention, when the first pull-down transistor NT3 has the same channel length as the second pull-down transistor NT17, the first pull-down transistor NT3 has a channel width of about 7,000 micrometers and the second pull-down transistor NT17 has a channel width of about 700 micrometers.

As described above, the dummy stage DSRC includes the first output terminal OUT1 connected to the reset terminal RE of the driving stages SRC1˜SRCn and the second output terminal OUT2 connected to the control terminal CT of the last driving stage SRCn and separated from the first output terminal OUT1. Thus, the output characteristics of the dummy gate signal are applied to the last driving stage SRCn, thereby preventing distortion of the gate signal output from the last driving stage SRCn.

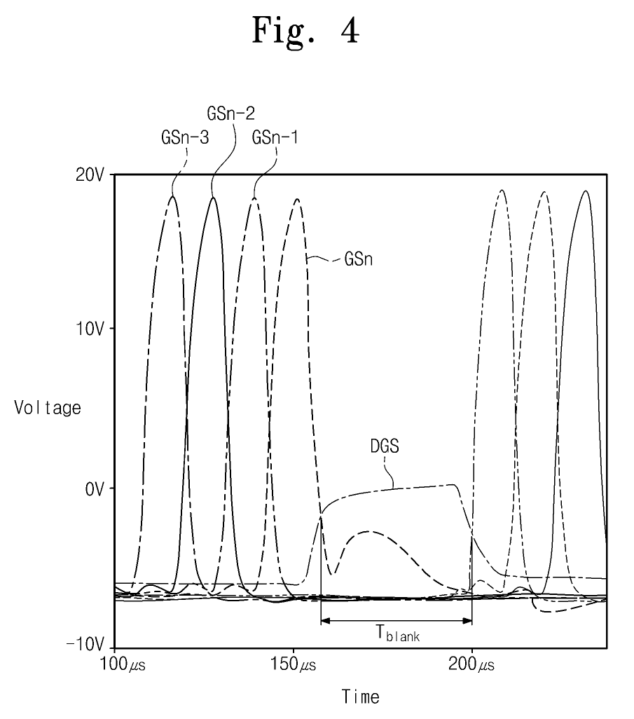

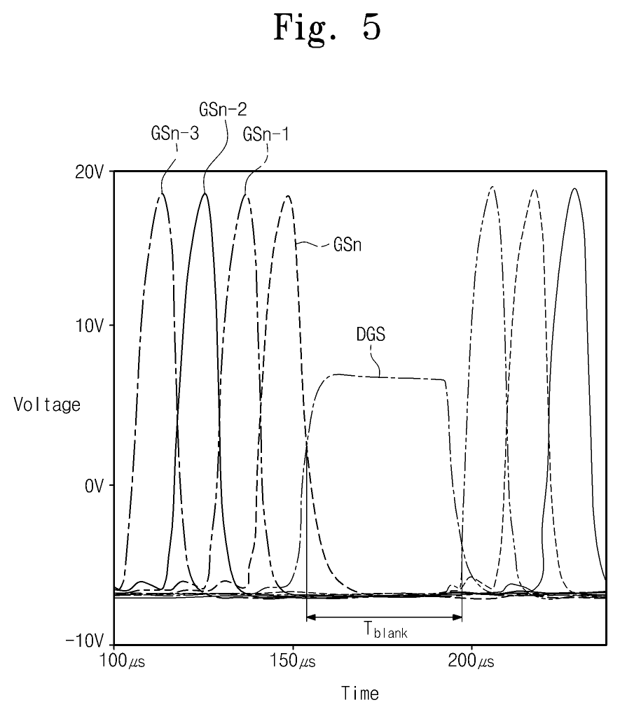

FIG. 4 is a waveform diagram illustrating gate signals output from a conventional gate driver, and FIG. 5 is a waveform diagram illustrating gate signals output from an exemplary embodiment of a gate driver according to the present invention.

FIG. 4 shows the gate signal GSn from the last driving stage SRCn and the dummy gate signal DGS output from the output terminal of the dummy stage DSRC wherein the output terminal of the dummy stage DSRC is commonly connected to the reset terminal RE of the driving stages SRC1˜SRCn and the control terminal CT of the last driving stage SRCn.

When the output terminal of the dummy stage DSRC is connected to the reset terminals RE of all the previous driving stages SRC1˜SRCn and the control terminal CT of a previous stage SRCn, a load connected to the output terminal increases. Due to the load, the dummy gate signal DGS does not increase to a desired level needed to turn on the transistors connected to the control terminal CT of the last driving stage SRCn, e.g., pull-down transistor NT3, discharge transistors NT5 and NT15 shown in FIGS. 1 and 2. As a result, the gate signal GSn of the last driving stage SRCn is undesirably output in a blank period Tblank, where, ideally, the gate signal GSn would be absent and the dummy gate signal DGS would be greater than a threshold voltage of the transistors connected to the control terminal CT of the last driving stage SRCn.

However, when the dummy stage DSRC includes the first output terminal OUT1 connected to the reset terminal RE of the driving stages SRC1˜SRCn and the second output terminal OUT2 connected to the control terminal CT of the last driving stage SRCn, as shown in FIG. 5, the dummy gate signal DGS output from the second output terminal OUT2 increases higher than a threshold voltage of transistors NT2, NT5 and NT15 connected to the control terminal CT of the last driving stage SRCn. Thus, the gate signal GSn of the last driving stage SRCn may be normally discharged during the blank period Tblank by the dummy gate signal DGS.

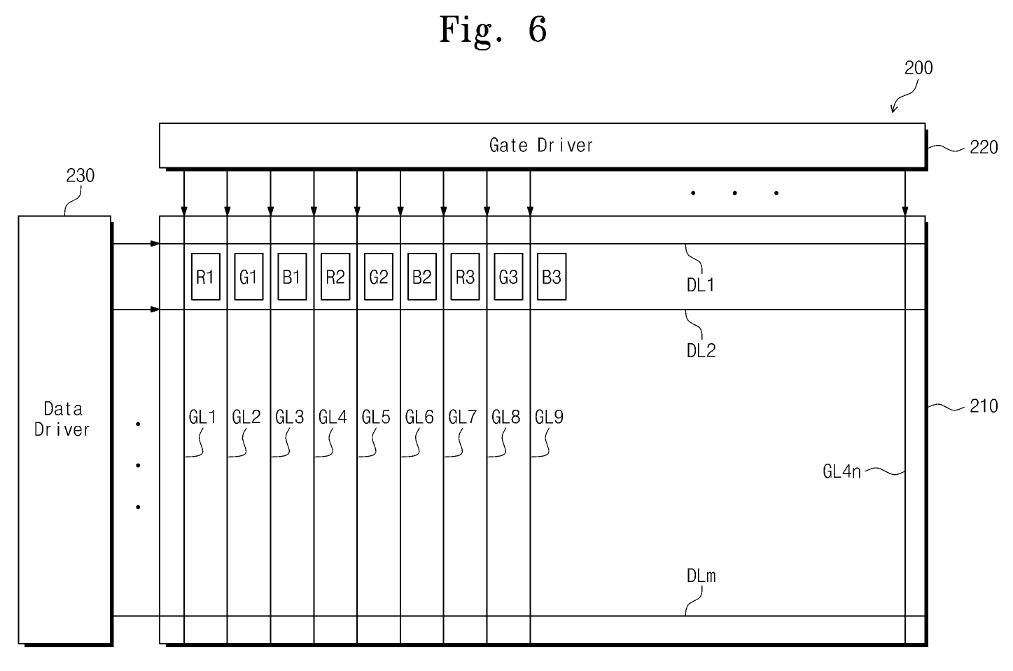

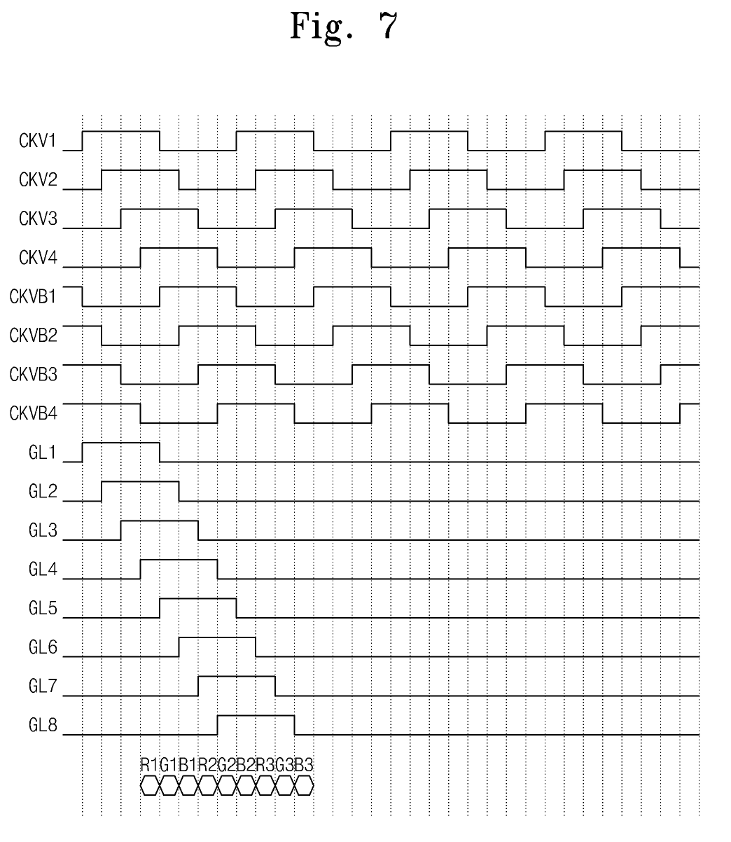

FIG. 6 is a top plan layout view illustrating an exemplary embodiment of a display apparatus according to the present invention, and FIG. 7 is a waveform diagram illustrating signals applied to gate lines of FIG. 6.

Referring to FIG. 6, a display apparatus 200 includes a display panel 210 that displays an image, a gate driver 220 that outputs the gate signal to the display panel 210, and a data driver 230 that outputs the data signal to the display panel 210.

In one exemplary embodiment, the display panel 210 maybe a liquid crystal display (“LCD”) panel including a lower substrate, an upper substrate facing the lower substrate, and a liquid crystal layer (not shown) interposed between the lower substrate and the upper substrate.

The display panel 210 includes a plurality of pixel areas in a matrix form. In one exemplary embodiment, the pixel areas are bounded by gate lines GL1˜GL4n and data lines DL1˜DLm insulated from and disposed substantially perpendicularly to the gate lines GL1˜GL4n. Pixels are arranged in the pixel areas, respectively, and in one exemplary embodiment, color pixels are arranged corresponding to the pixels, respectively. In one exemplary embodiment, the display panel 210 may include red, green and blue color pixels R, G and B.

In the present exemplary embodiment, the display panel 210 has a rectangular shape of which a length in a direction parallel to the data lines DL1˜DLm is longer than a length in a direction perpendicular to the data lines DL1˜DLm, so that the number of the gate lines GL1˜GL4n is more than the number of the data lines DL1˜DLm. The pixels R, G and B have a vertical pixel structure of which a length in a direction parallel to the gate lines GL1˜GL4n is longer than a length in a direction perpendicular to the gate lines GL1˜GL4n. However, the shape of the display panel 210 and the pixels R, G and B may be varied to have different shapes as would be apparent to one of ordinary skill in the art.

The gate driver 220 is electrically connected to the gate lines GL1˜GL4n to sequentially apply the gate signal to the gate lines GL1˜GL4n. The data driver 230 is electrically connected to the data lines DL1˜DLm to apply the data signal to the data lines DL1˜DLm.

In one exemplary embodiment, the gate driver 220 may be directly formed on the display panel 210 through a thin film process that is applied to form the pixels on the display panel 210, and the data driver 230 is manufactured in a chip form and mounted on the display panel 210. However, different configurations of the gate driver 220 and the data driver 230 are within the scope of the present invention, e.g., both the gate driver 220 and the data driver 230 may be disposed directly on the display panel 210, or both the gate driver 220 and the data driver 230 may be manufactured in chip form and mounted on the display panel 210.

Referring to FIG. 7, the gate driver 220 receives first, second, third and fourth clocks CKV1, CKV2, CKV3 and CKV4, and fifth, sixth, seventh and eighth clocks CKVB1, CKVB2, CKVB3 and CKVB4. In the present exemplary embodiment, the fifth to eighth clocks CKVB1, CKVB2, CKVB3 and CKVB4 have the opposite phase to that of the first to fourth clocks CKV1, CKV2 CKV3 and CKV4, respectively.

In the exemplary embodiment wherein the length of one frame is 1F hour and the number of the gate lines GL1˜GL4n is 4n (wherein n is a constant number equal to or larger than 1), the first to fourth clocks CKV1, CKV2, CKV3 and CKV4 are maintained in a high state during IF/n hour (hereinafter, referred to as 1H hour). The second clock CKV2 is delayed by H/4 with respect to the first clock CKV1, the third clock CKV3 is delayed by H/4 with respect to the second clock CKV2, and the fourth clock CKV4 is delayed by H/4 with respect to the third clock CKV3.

The gate signals generated corresponding to the high period of the first to fourth clocks CKV1, CKV2, CKV3 and CKV4 are sequentially applied to the first to fourth gate lines GL1, GL2, GL3 and GL4, respectively. The gate signals generated corresponding to the high period of the fifth to eighth clocks CKVB1, CKVB2, CKVB3 and CKVB4 are sequentially applied to the fifth to eighth gate lines GL5, GL6, GL7 and GL8, respectively.

Although not shown in FIGS. 6 and 7, the gate driver 220 may include four shift registers that receive the first to fourth clocks CKV1, CKV2, CKV3 and CKV4, respectively, and receive the fifth to eighth clocks CKVB1, CKVB2, CKVB3 and CKVB4, respectively. For example, in one exemplary embodiment, the first shift register may receive the first clock signal CKV1 and the fifth clock signal CKVB1; the second shift register may receive the second clock signal CKV2 and the sixth clock signal CKVB2; the third shift register may receive the third clock signal CKV3 and the seventh clock signal CKVB3; and the fourth shift register may receive the fourth clock signal CKV4 and the eighth clock signal CKVB4.

As the number of the gate lines GL1˜GL4n increases, the number of the shift registers in the gate driver 220 may also increase. In this case, the dummy stage DSRC includes the first output terminal OUT1 connected to the reset terminal of the driving stages SRC1˜SRCn and the second output terminal OUT2 connected to the control terminal CT of the last driving stage SRCn.

Accordingly, although the load connected to the first output terminal OUT1 increases due to the increase of the number of the driving stages, the dummy gate signal applied to the last driving stage SRCn is not distorted. Thus, the last driving stage SRCn may be normally turned off by the dummy gate signal, thereby preventing line defects from occurring on the display penal 210, which is caused by the malfunction of the last driving stage SRCn.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A gate driver comprising:
a plurality of driving stages, each of which comprises:
an input terminal which receives a previous carry signal from a previous driving stage;
a control terminal which receives a next gate signal from a subsequent driving stage;
an output terminal which outputs a present gate signal and is connected to the control terminal of the subsequent driving stage;
a carry terminal which outputs a present carry signal and is connected to the input terminal of the subsequent driving stage; and
a reset terminal which receives a reset signal; and
a dummy stage comprising:
an input terminal which receives a last carry signal from a last driving stage of the plurality of driving stages;
a control terminal which receives a control signal;
a first output terminal which applies the reset signal to the reset terminal of each of the plurality of driving stages; and
a second output terminal which applies a dummy gate signal to the control terminal of the last driving stage of the plurality of driving stages.

2. The gate driver of claim 1, wherein the dummy stage further comprises:
a first pull-up part that pulls up the reset signal output through the first output terminal;
a second pull-up part that pulls up the dummy gate signal output through the second output terminal;
a pull-up driving part that turns on the first pull-up part and the second pull-up part in response to the last carry signal and turns off the first pull-up part and the second pull-up part in response to the control signal; and
a pull-down part that pulls down the reset signal and the dummy gate signal to a gate-off voltage in response to the control signal.

3. The gate driver of claim 2, wherein the first pull-up part comprises:
a first pull-up transistor having a control electrode connected to an output of the pull-up driving part, an input electrode receiving a clock, and an output electrode connected to the first output terminal, and
wherein the second pull-up part comprises:
a second pull-up transistor having a control electrode connected to the output of the pull-up driving part, an input electrode receiving the clock, and an output electrode connected to the second output terminal.

4. The gate driver of claim 3, wherein the second pull-up transistor has a size smaller than a size of the first pull-up transistor, and the size of each transistor represents one of a channel width of the respective transistor and a ratio of the channel width of the respective transistor to a channel length of the respective transistor.

5. The gate driver of claim 2, wherein the pull-down part comprises:
a first pull-down transistor including a control electrode connected to the control terminal, an input terminal receiving the gate-off voltage, and an output electrode connected to the first output terminal; and
a second pull-down transistor including a control electrode connected to the control terminal, an input terminal receiving the gate-off voltage, and an output electrode connected to the second output terminal.

6. The gate driver of claim 5, wherein the second pull-down transistor has a size smaller than a size of the first pull-down transistor, and the size of each transistor represents one of a channel width of the respective transistor and a ratio of the channel width of the respective transistor to a channel length of the respective transistor.

7. The gate driver of claim 1, wherein the input terminal of a first driving stage of the plurality of driving stages receives a vertical start signal in lieu of the previous carry signal, and the control signal applied to the control terminal of the dummy stage comprises the vertical start signal.

8. The gate driver of claim 1, wherein each of the driving stages comprises:
a pull-up part which pulls up the present gate signal output through the output terminal;
a carry part which pulls up the present carry signal output through the carry terminal;
a pull-up driving part which turns on the pull-up part and the carry part in response to the previous carry signal and turns off the pull-up part and the carry part in response to the next gate signal;
a pull-down part which pulls down the present gate signal and the present carry signal to a gate-off voltage in response to the next gate signal; and
a reset part which turns off the pull-up part and the carry part in response to the reset signal output from the first output terminal of the dummy stage.

9. The gate driver of claim 8, wherein the reset part comprises a reset transistor having a control electrode connected to the first output terminal of the dummy stage to receive the reset signal, an input electrode receiving the gate-off voltage, and an output electrode connected to a control electrode of the carry part and the pull-up part.

10. A display apparatus comprising:
a display panel including:
a plurality of gate lines;
a plurality of data lines disposed substantially perpendicular to the plurality of gate lines; and
a plurality of pixels, each of which is connected to at least one of the plurality of gate lines and at least one of the plurality of data lines;
a data driver which applies a data signal to the plurality of data lines; and
a gate driver which sequentially applies a gate signal to the plurality of gate lines, wherein the gate driver comprises:
a plurality of driving stages, each of which comprises:
an input terminal which receives a previous carry signal from a previous driving stage;
a control terminal which receives a next gate signal from a subsequent driving stage;
an output terminal which outputs a present gate signal and is connected to the control terminal of the subsequent driving stage;
a carry terminal which outputs a present carry signal and is connected to the input terminal of the subsequent driving stage; and
a reset terminal which receives a reset signal; and
a dummy stage comprising:
an input terminal which receives a last carry signal from a last driving stage of the plurality of driving stages;
a control terminal which receives a control signal;
a first output terminal which applies the reset signal to the reset terminal of each of the plurality of driving stages; and
a second output terminal which applies a dummy gate signal to the control terminal of the last driving stage of the plurality of driving stages.

11. The display apparatus of claim 10, wherein the dummy stage comprises:
a first pull-up part which pulls up the reset signal output through the first output terminal;
a second pull-up part which pulls up the dummy gate signal output through the second output terminal;
a pull-up driving part which turns on the first and second pull-up parts in response to the last carry signal and turns off the first and second pull-up parts in response to the control signal; and
a pull-down part which pulls down the reset signal and the dummy gate signal to a gate-off voltage in response to the control signal.

12. The display apparatus of claim 11, wherein the first pull-up part comprises a first pull-up transistor having a control electrode connected to an output of the pull-up driving part, an input electrode receiving a clock, and an output electrode connected to the first output terminal, and
wherein the second pull-up part comprises a second pull-up transistor having a control electrode connected to the output of the pull-up driving part, an input electrode receiving the clock, and an output electrode connected to the second output terminal.

13. The display apparatus of claim 11, wherein the pull-down part comprises:
a first pull-down transistor including a control electrode connected to the control terminal, an input terminal receiving the gate-off voltage, and an output electrode connected to the first output terminal; and
a second pull-down transistor including a control electrode connected to the control terminal, an input terminal receiving the gate-off voltage, and an output electrode connected to the second output terminal.

14. The display apparatus of claim 10, wherein each of the plurality of driving stages comprises:
a pull-up part which pulls up the present gate signal output through the output terminal;
a carry part which pulls up the present carry signal output through the carry terminal;
a pull-up driving part which turns on the pull-up part and the carry part in response to the previous carry signal and turns off the pull-up part and the carry part in response to the next gate signal;
a pull-down part which pulls down the present gate signal and the present carry signal to a gate-off voltage in response to the next gate signal; and
a reset part which turns off the pull-up part and the carry part in response to the reset signal output from the first output terminal of the dummy stage.

15. The display apparatus of claim 14, wherein the output terminal of each of the driving stages is electrically connected to a first end of a corresponding gate line of the plurality of gate lines, and each of the driving stages further comprises a discharge part electrically connected to a second end of the corresponding gate line to discharge the present gate signal applied to the corresponding gate line in response to the next gate signal from one of a subsequent driving stage and the dummy stage.

16. The display apparatus of claim 15, wherein the display panel further comprises a dummy gate line which electrically connects the second output terminal of the dummy stage to the discharge part connected to the last driving stage.

17. The display apparatus of claim 10, wherein the display panel has a rectangular shape of which a length in a direction substantially parallel to the data lines is longer than a length in a direction substantially perpendicular to the data lines, and a number of the gate lines is more than a number of the data lines.

18. The display apparatus of claim 17, wherein the gate driver is directly formed on the display panel through a thin film process.

19. A method of manufacturing a gate driver, the method comprising:
forming a plurality of driving stages, each of which comprises:
an input terminal which receives a previous carry signal from a previous driving stage;
a control terminal which receives a next gate signal from a subsequent driving stage;
an output terminal which outputs a present gate signal and is connected to the control terminal of the subsequent driving stage;
a carry terminal which outputs a present carry signal and is connected to the input terminal of the subsequent driving stage; and
a reset terminal which receives a reset signal; and
forming a dummy stage comprising:
an input terminal which receives a last carry signal from a last driving stage of the plurality of driving stages;
a control terminal which receives a control signal;
a first output terminal which applies the reset signal to the reset terminal of each of the plurality of driving stages; and
a second output terminal which applies a dummy gate signal to the control terminal of the last driving stage of the plurality of driving stages.
